(19) United States
(12) Patent Application Publication
(10) Pub. No.: US 2024/0035881 A1
(43) Pub. Date: Feb. 1, 2024

(54) DEVICE AND METHOD FOR MEASURING IRRADIANCE

(71) Applicant: Sencrop, Lomme (FR)

(72) Inventors: Bruno Boissenin, Faches Thumesnil (FR); Jérémy Masson, Montsoult (FR); Steven Debeire, Lille (FR)

(21) Appl. No.: 18/258,652

(22) PCT Filed: Dec. 21, 2021
(86) PCT No.: PCT/EP2021/087035

§ 371 Date: Jun. 21, 2023

(30) Foreign Application Priority Data
Dec. 21, 2020 (FR) 2013867

(51) Int. Cl. G01J 1/02; G01J 1/16; G01J 1/04

(52) U.S. Cl. CPC G01J 1/0295; G01J 1/16; G01J 1/0418; G01J 2001/4266

(57) ABSTRACT

A device, in particular, a pyranometer, for measuring solar irradiance, comprises a light detection means and a temperature measurement means, and for which the temperature measurement means is configured to measure the temperature of the light detection means, and a data processing means configured to determine the irradiance by taking into account, in situ, the temperature of the light detection means. An irradiance measurement system and an irradiance measurement method are also disclosed.

### CROSS-REFERENCE TO RELATED APPLICATIONS

This application is a national phase entry under 35 U.S.C. § 371 of International Patent Application PCT/EP2021/087035, filed Dec. 21, 2021, designating the United States of America and published as International Patent Publication WO 2022/136396 A1 on Jun. 30, 2022, which claims the benefit under Article 8 of the Patent Cooperation Treaty to French Patent Application Serial No. FR2013867, filed Dec. 21, 2020.

### TECHNICAL FIELD

The present disclosure relates to a device, in particular, a pyranometer, to determine a measurement of solar irradiance and a system comprising such a device. The present disclosure also relates to a method for measuring irradiance.

### BACKGROUND

A pyranometer is a sensor used for measuring the quantity of solar energy in natural light and is, in particular, used in meteorology. It ensures the measuring of total power of solar radiation in watts per square meter. In the field of agriculture, this value is important, as it gives information about the evapotranspiration of water, which relates to all phenomena leading to the evaporation of water through plants and soil, and therefore about the necessity of not to irrigate the fields. This value also makes it possible to control and evaluate the water stress of different species, i.e., the resilience of species to the absence of irrigation. Such devices are known in the state of the art, for example, in WO 2009/068710 A1 or EP 3480570 A1.

The pyranometers known in the state of the art can be divided into two categories: those that use a thermoelectric effect to measure the short-wave incident radiation by using thermopiles, and those that use a photoelectric effect by using photodiodes. Generally, instruments relying on the thermoelectric effect are considered as more accurate and more expensive.

Although photodiodes have an advantage due to their low cost and to their simple design, they have a limited spectral sensitivity range, generally between 400 nm and 1100 nm. In addition, they require a calibration using an external source of spectral properties comparable to the sun. This calibration can be, for example, done manually by adjusting a potentiometer, such that the output signal corresponds to the power of the radiation of the external source. In addition, potentiometers are also subject to thermal drifts, which can falsify the calibration of photodiodes.

Thus, the reliability of the measurement remains to be improved.

### BRIEF SUMMARY

The present disclosure aims to improve the reliability of measuring solar irradiance by a device, in particular, a pyranometer, which makes it possible to obtain a solar irradiance measurement accurately, simpler and more effectively, by providing an improved calibration with respect to the device of the state of the art.

The aim of the present disclosure is achieved by providing a device, in particular, a pyranometer, for measuring solar irradiance, comprising a light detection means, in particular, a photodiode, and a temperature measuring means, the temperature measuring means being configured to measure the temperature of the light detection means, and a data processing means configured to determine the irradiance by considering, in situ, the temperature of the light detection means. Thus, the effect of the temperature of the measurement can be considered. Indeed, the output signal of the light detection means, for example, a current or a voltage, can be impacted by a change in temperature. Thus, the accuracy of the device can be improved with respect to the devices of the state of the art.

According to a variant of the present disclosure, the temperature measuring means and the light detection means can be mounted on one same printed circuit, in particular, side-by-side. Thus, the temperature sensor is in thermal contact with the light detection means and makes it possible to measure the actual temperature of the light detection means and not the ambient temperature outside of inside the device. This actual temperature can be greater than the ambient temperature. The measurements taken by the device can therefore be corrected by considering the temperature of the detection means and make it possible to reduce the impact of the temperature on the measurements of the light detection means. Thus, the accuracy of the device can be improved.

According to a variant of the present disclosure, the light detection means can be a photodiode configured to be used in inverse polarization. Contrary to the “open circuit” operation having a logarithmic response to the power of the incoming radiation and therefore a high sensitivity to temperature, the inverse polarization photodiode has a linear response of the voltage according to the irradiance. This makes it possible to further reduce the impact of the temperature on the irradiance measurement of the device according to the present disclosure with respect to the measurement taken with a photodiode used as a voltage generator, or also called photovoltaic-mode photodiode. In addition, the response is quicker than in the “open circuit” mode.

According to a variant, the device can further comprise a conversion means, in particular, a resistance, even more in particular, a fixed resistance, the conversion means being connected to the light detection means. The conversion means makes it possible to convert the photocurrent I of the photodiode into output voltage U, by the ratio U=a*I, “a” being a value of the conversion means. By using a fixed resistance as a conversion means, no manual adjustment such as with a potentiometer typically used in the devices of the state of the art, becomes necessary. In addition, by choosing, preferably, a resistance with a strong temperature stability of around 10 PPM/° C. or better, the device according to the present disclosure becomes even less sensitive to temperature.

According to a variant of the present disclosure, the conversion means can be mounted on the same printed circuit, on which the temperature measuring means and the light detection means are mounted. Thus, the temperature sensor is also in thermal contact with the conversion means and makes it possible to measure the actual temperature of the conversion means. The measurements taken by the device can therefore be correct by considering the temperature of the conversion means and make it possible to reduce the impact of the temperature on the conversion means. Thus, the accuracy of the device can be improved with respect to the devices of the state of the art.

According to a variant of the present disclosure, the data processing means can comprise a microprocessor, a memory, in particular, an EEPROM-type memory, and an analog-to-digital converter. Preferably, the memory can comprise a list of calibration coefficients “b(T)” according to the temperature T and the data processing means can be configured to determined the irradiance Y by using one or more calibration coefficients b(T) stored in the memory, in particular, based on the ratio Y=b(T)*U+c, c being able to be zero. By using such a data processing means, it becomes possible to take a measurement of the irradiance by the light detection means by using the calibration coefficient of the light detection means corresponding to the temperature measured of the light detection means. This correction of the measurement of the irradiance according to the temperature is made internally and in situ to the device, which, in addition, is digital.

According to a variant of the present disclosure, the memory can comprise a table of calibration coefficients according to the temperature and the data processing means can be configured to determine the irradiance according to the temperature by using one or more calibration coefficients of the table of calibration coefficients stored in the memory. Thus, the calibration of the light detection means is done by considering its temperature and makes it possible to reduce the impact of the temperature on the measurement of the irradiance of the light detection means. Thus, the accuracy of the device can be improved with respect to the devices of the state of the art.

According to a variant of the present disclosure, the device can comprise an optical filter placed upstream of the light detection means, with respect to the incoming radiation during the use of the device. The filter can, preferably, be disposed between an opening of the device and the light detection means. Thus, the light detection means is protected by the optical filter of possible degradations due to the exposure to UV rays or to chemical products, or due to being covered by contaminants such as dust or pollen.

According to a variant of the present disclosure, the optical filter can be a neutral density filter, in particular, a neutral density reflection filter, even more in particular, a neutral density metal filter. The use of a neutral density filter makes it possible to decrease the intensity of the incoming radiation in the device and arriving on the light detection means, without altering the relative spectral distribution of energy. Thus, the light detection means receives a sufficiently low quantity of radiation to not saturate it. Preferably, the neutral density filter is a neutral density metal filter that dampens light by reflection and is less sensitive to temperature variations than glass or gelatine neutral density filters. Thus, given that solar energy is not absorbed but reflected but reflected by the filter, the internal temperature of the casing is reduced, which makes it possible, even more, to reduce the effect of the temperature on the measurements of the device.

According to a variant of the present disclosure, the device can further comprise a communication means, in particular, a wireless communication means. Thus, the device can be connected to a remote center thanks to its communication means to exchange data. Based on the data exchanged, the device can be tested remotely, or be recalibrated, or updated, where it can be decided to carry out maintenance of the device.

The aim of the present disclosure is also achieved by a system for measuring solar irradiance, comprising at least one device for measuring solar irradiance as described above, a comparative device having a light detection means of the same type as the at least one device for measuring solar irradiance, wherein the comparative device comprises a communication means, in particular, a wireless communication means, and the comparative device is configured to send information relating to a calibration coefficient to the at least one device for measuring irradiance via the communication means. Thus, the system can remotely compare the light detection means of the comparative device to that of the at least one other device for measuring solar irradiance, without needing to return the at least other device for measuring solar irradiance to the factory. Based on the data of the comparative device, the system can verify the calibration of the at least one device for measuring solar irradiance and decide if a recalibration of the at least one device for measuring solar irradiance is necessary. Preferably, the comparative device can be placed to the side of a standard device having an accuracy greater than the light detection means of the comparative device and that sends its data to the comparative device.

According to a variant, the comparative device can comprise a temperature measuring means configured to measure the temperature of the light detection means, and can be configured to send information relating to the calibration coefficient according to the temperature. The comparative device itself also takes a measurement of the irradiance made according to the temperature of its light detection means. Thus, based on the data of the comparative device, the system can verify the operation of the at least one device. The at least one device, already in position in a field, can thus be remotely tested, or be recalibrated, or updated, where it can be decided to carry out maintenance of the device.

The aim of the present disclosure is also achieved by a method for measuring irradiance, in particular, solar irradiance, using a pyranometer device or a system as described above comprising a step of measuring a voltage (U) representative of the incident irradiance on the light detection means and, a step of measuring the temperature of the light detection means by a temperature measuring means, and a step of calculating in situ incident irradiance (Y) by the data processing means of the incident irradiance based on the voltage (U) measured and by using a calibration coefficient b(T) of the table of calibration coefficients chosen according to the temperature T measured.

Thus, the temperature sensor makes it possible to measure the actual temperature of the light detection means and not the ambient temperature outside or inside the device. The measurements taken by the device can therefore be corrected by considering the temperature of the detection means and make it possible to reduce the impact of the temperature on the measurements of the light detection means. Thus, the accuracy of the device can be improved with respect to the devices of the state of the art. In addition, it is possible to perform a calibration of the light detection means internal to the device, in particular, a self-calibration. Thus, it is not necessary to manually intervene on a component such as a potentiometer. In addition, it is not necessary to return the device to the manufacturer to perform a calibration or a recalibration of the device by using external calibration means. This enables a rapid and less expensive calibration or recalibration of the device.

According to a variant of the present disclosure, the method for measuring irradiance using a pyranometer device or a system as described above can comprise a step of receiving one or more calibration coefficient b(T) values modified by the communication means and the replacement of the existing corresponding value(s) in the data processing means by the value(s) received. Thus, it becomes possible to update the calibration coefficients without physical intervention of a user or without returning the device to the factory to, for example, consider a change in calibration coefficients due to aging. This updating/correction is done internally and in situ in the device.

According to a variant, the method can comprise a step of receiving, by the comparative device, a solar irradiance value measured by a standard device having an accuracy greater than the light detection means of the comparative device, the comparative device being positioned adjacent to the standard device, a step of comparing the value received with the irradiance measured by the comparative device, a step of calculating calibration coefficients of the comparative device modified according to the solar irradiance data received by the comparative device and a step of sending the calculated calibration coefficients of the comparative device to the at least one device for measuring the solar irradiance. Thus, by using the data received of a standard device having a better accuracy, it becomes possible to identify changes in the response of the light detection means, for example, due to aging of the light detection means, and to correct the calibration coefficients of the other light detection means of the same type remotely.

### BRIEF DESCRIPTION OF THE DRAWINGS

The present disclosure can be understood by referring to the following description taken together with the accompanying figures, wherein number references identify the elements of the present disclosure.

FIG. 1A schematically represents a view of the device for measuring irradiance according to a first embodiment of the present disclosure.

FIG. 1B represents a cross-sectional view of the device of FIG. 1A.

FIG. 1C illustrates the steps of using the device of FIG. 1A.

FIG. 2 shows a device according to a third embodiment of the present disclosure.

FIG. 3A shows a system for measuring irradiance according to a fourth embodiment of the present disclosure.

FIG. 3B shows a diagram of the method for adapting a table of calibration coefficients by using the system such as illustrated in FIG. 3A.

### DETAILED DESCRIPTION

The present disclosure is described in more detail below by using advantageous embodiments by way of example and with reference to the drawings. The embodiments described are simply possible configurations, and the spirit must be kept, that the individual features such as described above can be provided independently from one another, or can be omitted during the implementation of the present disclosure.

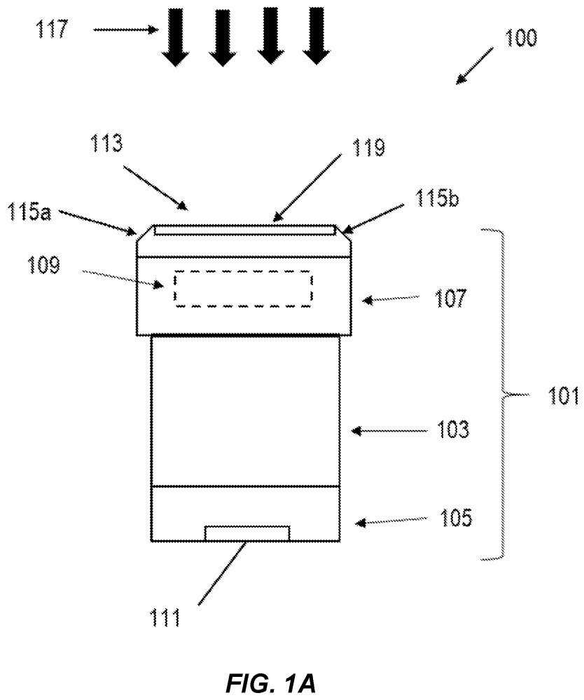

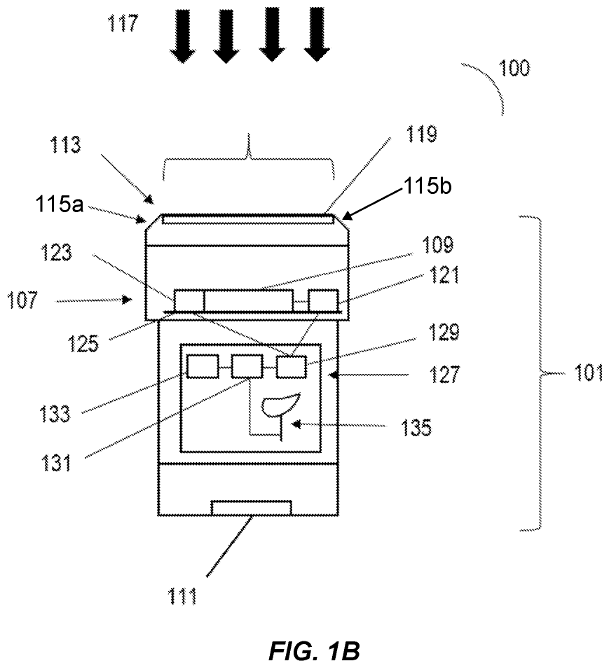

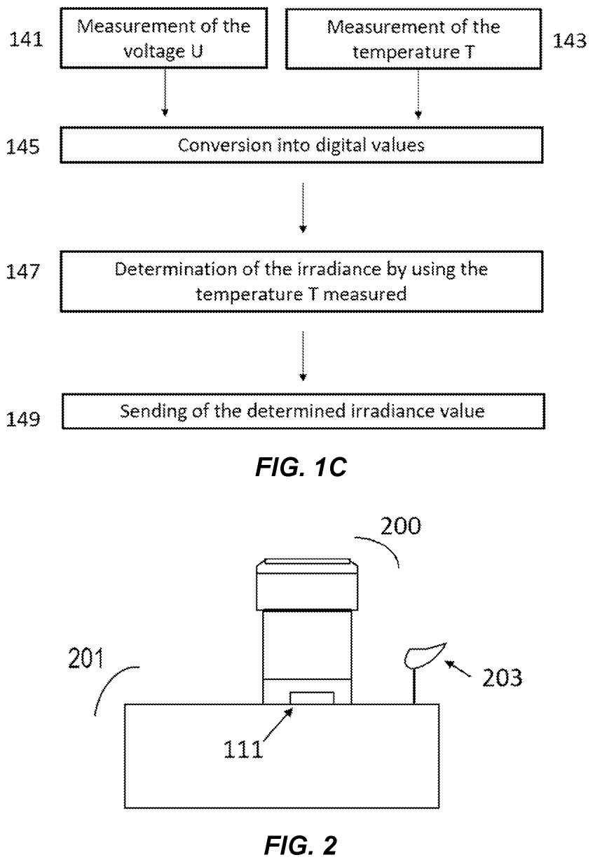

FIGS. 1A and 1B represent a device for measuring irradiance 100 according to a first embodiment of the present disclosure. In this case, the device 100 is a pyranometer. A pyranometer measures the irradiance, therefore the power of the incoming radiation per surface unit measured in W/m². The irradiance measured can be the solar irradiance or also the irradiance of any light source.

As illustrated in FIG. 1A, the device 100 comprises a casing 101 with a cylindrical main part 103, a support base 105 and a cover 107. The main part 103, the support base 105 and the cover 107 are connected together so as to form a hermetic casing. Thus, the inside of the casing 101, in particular, a light detection means 109 illustrated as a dotted line, can be protected from bad weather.

The lower part of the support base 105 of the casing 101 can comprise a connection means 111 making it possible to position the device 100 on a weather station, such as illustrated in FIG. 2. The connection means 111 can be a “plug and play”-type means, enabling a rapid and simple mechanical and electrical connection with a weather station having a compatible connection interface.

The cover 107 has a through hole defining an opening 113. Preferably, the cover 107 has beveled edges 115a, 115b to facilitate the discharge of water. In this embodiment, the cover 107 exceeds the wall of the main part 103 to repel rainwater from the wall of the main part 103.

The opening 113 lets solar radiation 117 enter inside the device. An optical filter 119 is placed in the opening 113 to dampen the intensity of the incoming radiation 117.

In this embodiment, the optical filter 119 is a neutral density filter. Preferably, a reflection optical filter 119 is used, which comprises a metal layer on a borosilicate glass or polished fused silica window. The optical filter 119 covers a range of wavelengths of 350 nm to 2500 nm to decrease the intensity of the incoming radiation 117 without altering the relative spectral distribution of energy. The optical filter 119 filters the visible spectrum evenly, thus reducing the quantity of radiation arriving on the photodiode 109, without impacting the color or the contrast. Thus, the light detection means 109 receives a quantity of radiation sufficiently low to not saturate.

The fact that the optical filter 119 is preferably a neutral density reflection filter makes it possible to reduce the quantity of incoming radiation in the device, which makes it possible to avoid an increase in temperature in the device due to a stronger absorption.

The optical filter 119 can, for example, be a Knight Optical neutral density metal filter, model FNM1525. The FNM1525 filter has a transmission of 3.2% at 546 nm, with an optical density of 1.5. The filter has, as a dimension, a diameter of around 25 mm, and a thickness of around 2 mm. With the filter being a flat filter, it comprises a flatness less than 2λ out of more than 90% of the diameter of the filter. In a variant of the embodiment, any other type of neutral density optical filter can be used, according to the light spectrum necessary for the application of the device 100.

Such as illustrated in the cross-section of the device 100 in FIG. 1B, the light detection means 109 is positioned under the optical filter 119, inside the casing 101, in particular, inside the cover 107, to receive the incoming radiation 117.

According to a variant, an optical system comprising one or more lenses can be positioned between the optical filter 119 and the light detection means 109, so as to concentrate the incoming light in the device through the optical filter 119 on the light detection means 109.

The light detection means 109 in the first embodiment is a photodiode. Alternatively, any other type of light sensor can be used such as a thermopile. The photodiode 109 can, for example, be a VISHAY silicon photodiode, model VEMD6060X01. This photodiode is a PIN-type photodiode that comprises a sensitive zone of a dimension of 0.85 mm² detecting the radiation between 380 nm and 1070 nm.

According to the present disclosure, the photodiode 109 of the device 100 is used in inverse polarization, also called “photoconductive” mode. This means that the photodiode 109 is powered up and is, therefore, supplied with energy. The greater the quantity of radiation 117 received by the photodiode 109, the more the current, also called photocurrent, passing the photodiode 109 increases. The photodiode 109 is connected to a conversion means 121 to convert the photocurrent passing through the photodiode 109 in output voltage, which is directly proportional to the photocurrent.

The “photoconductive” mode makes it possible to reduce the response time of the photodiode 109 and enables quicker measurements with respect to the “open circuit” mode.

In addition, in the “photoconductive” mode, the output signal level to be measured depends on the conversion means 121 chosen, which is conveyed, in this case, by a voltage of around one volt (V) in the case of stronger radiations, while in the “open circuit” mode of a photodiode, the voltages to be measured are around 100 μV. This makes it possible to avoid having to use complex and expensive components to measure the voltage, as is the case in “open circuit.”

In addition, the output signal of the photodiode 109, in this case, an output current, or also photocurrent, measured is linear with the power of the incoming radiation 117. The application of an inverse polarization produces a linear response according to an equation given by: U=a*I, with ‘U’ the output voltage in volts (V), ‘I’ the output current in amps (A), and ‘a’ being a coefficient representative of the chosen conversion means 121. Then, Y=b*U+c is obtained, with ‘Y’ the irradiance in W/m², ‘U’ the output voltage in volts and ‘b’ being the calibration coefficient, specific to the photodiode 109 and ‘c’ being a parameter, which that could be zero. This linear response makes it possible to obtain a reduction in the impact of the temperature on the irradiance measurements of the photodiode 109 compared with the logarithmic response during an “open circuit” operation of the photodiode 109.

According to an embodiment, the conversion means 121 is a resistance. In this case, in particular, the chosen resistance is a fixed resistance, preferably with an accuracy of 0.1% or better to an ambient temperature, therefore between 20° C. and 25° C. Preferably, the temperature coefficient is 10 PPM/° C., that is 0.001%/° C. or better. The choice of such a resistance makes it possible to reduce the effect of the temperature on the calibration of the device.

In a variant, the conversion means 121 can be a transimpedance amplifier or any other device that makes it possible to convert a current into voltage.

According to the present disclosure, the device 100 comprises, in addition, a temperature measuring means 123, in particular, a temperature sensor. The temperature sensor 123 is located inside the casing 101, at a light detection means 109, in particular, directly side-by-side on the same printed circuit 125. The temperature sensor 123 is preferably in thermal contact with the light detection means 109.

According to the present disclosure, the temperature sensor 123 is thus configured to measure the temperature of the light detection means 109.

According to a variant, the printed circuit 125 is black in color, and/or a black external envelope is used for the printed circuit, to avoid the internal reflection of the incoming radiation 117 on the light detection means 109.

According to the present disclosure, the actual temperature of the light detection means 109 can therefore be considered to reduce the impact of the variations in temperature on the irradiance measurements, and thus increase the accuracy of the measurement. Indeed, the temperature has an impact on the calibration coefficient b, knowing that the inside of the device 100 can be subjected to temperatures going from around −20° C. to around 60° C. The calibration coefficient ‘b’ is therefore a function of the temperature b(T).

In a variant of the embodiment, the temperature is measured by the temperature sensor 123 at a regular time interval, for example, every five minutes, while the irradiance measurement itself is taken at a lot shorter regular time interval, for example, every second.

To be able to consider the temperature measurement of the light detection means 109, the device 100 comprises a data processing means 127 in the casing 101. The data processing means 127 comprises an analog-to-digital converter 129 to convert the signals received from the conversion means 121 and from the temperature measuring means 123. The data processing means 127 also comprises a microprocessor 131, which receives the numbered signals and is configured to determine the irradiance by using calibration coefficients b(T), which are stored in an EEPROM-type memory 133 with the temperature measured. The microprocessor 131 is also connected to a communication means 135, which makes it possible to send and/or receive data, in particular, to send the results of the irradiance measurement and/or to receive data, such as new calibration tables with the calibration coefficients b(T).

The calibration of the device 100 to obtain the table of calibration coefficients b(T) according to the temperature T is done as follows.

The device 100 is factory-calibrated on an assembled device 100. Once calibrated, the device 100 can therefore be put into use, generally on a modular weather station.

During the factory-calibration, the light detection means 109 is calibrated with a standard lamp, having a known radiation that is close to the spectral properties of the sun. To consider the temperature dependency, the device 100 is placed in a climate chamber and irradiance measurements are taken at different temperatures, for example, in a range going from −20° C. to 60° C. with 5° C. steps.

By choosing the conversion means 121, the output signal of the conversion means 121 can be adapted to the power actually received. In this case, the output voltage obtained at the terminals of the conversion means 121 can be adapted to the power actually received.

Thus, the components are chosen, such that the calibration coefficient ‘b’ between the irradiance ‘Y’ (in W/m²) and the output voltage ‘U’ (in mV), is around 1 in mVm²/W. Thus, when an output voltage of 600 mV is measured, this corresponds to an actual irradiance of 600 W/m².

During the calibration, the standard lamp illuminates the light detection means 109 with different intensities going from 0 to 1 Sun with steps, for example, with steps of 0.1 Sun. The irradiation unit of 1 Sun corresponds to 988 W/m², according to the standard AM 1.5G dated January 2003.

Then, a linear regression is used between the values measured and the known radiation values of the standard lamp to obtain the value of the calibration coefficient ‘b’ according to the temperature T measured by the temperature sensor 123. Thus, a table of calibration coefficients is obtained, comprising a plurality of calibration coefficients b(T). This table is then stored in the memory 133 of the data processing means 127.

In an industrial calibration process, it can be advantageous to calibrate each device 100 according to the radiation of a standard lamp for only one given temperature and model the dependency of the calibration coefficient ‘b’ for each device according to the temperature, based on the temperature dependency of the calibration coefficient ‘b’ obtained by a sample, for example, fifty to several hundred devices with photodiodes 109 of the same type.

According to the present disclosure, the calibration is done digitally, avoiding any manual intervention on the hardware components of the device. Contrary to the devices of the state of the art, no potentiometer adjustment is necessary. At the same time, the device according to the present disclosure becomes less sensitive to the variations in temperature of the photodiode.

The device for measuring irradiance 100 according to the present disclosure is used as illustrated in FIG. 1C.

When the device 100 is used, for example, in a field, to measure the ambient irradiance, the voltage U is determined at the output of the conversion means (step 141) and the temperature T of the light detection means 109 is measured by the temperature measuring means 123 (step 143). In step 145, the two values U and T are converted by the analog-to-digital converter 129.

Then, in step 147, the microprocessor 131 determines the irradiance by using the calibration coefficient ‘b’ corresponding to the temperature measured in step 143 of the light detection means 109 by using the table of calibration coefficients stored in the memory 133. Thus, the impact of the temperature of the light detection means 109 on the calibration coefficient value ‘b’ is considered to obtain a more accurate measurement of the irradiance.

Finally, in step 149, by using the communication means 135 of the device 100, the irradiance value determined in step 147 can be sent to the user remotely. The communication means 135 of the device 100 also enables the device 100 to receive a new table of calibration coefficients of a central unit to, for example, be able to update the table of calibration coefficients. The new table of calibration coefficients received by the device 100 can comprise one or more modified calibration coefficient values b(T). A step of replacing the table of calibration coefficients with the new table of calibration coefficients is thus carried out in the data processing means 127. Thus, the updating/correction of the calibration table of the light detection means is done in situ to the device 100. It is not necessary to return the device to the manufacturer to perform a calibration or a recalibration of the light detection means of the device by using manual external calibration means.

According to a variant, the device 100 can receive only one or more calibration coefficient values b(T) modified by the communication means 135 and not a new table of calibration coefficients b(T). In this case, the updating of the table of calibration coefficients in the memory is done by replacing the corresponding value(s) existing in the data processing means by the value(s) received.

According to a second embodiment, instead of using a fixed resistance with a low temperature dependency, it is also possible to use a resistance for which the temperature dependency is known. This dependency of the resistance value according to the temperature is stored in the memory 133 together with the calibration coefficients b(T). In this embodiment, the data processing means 127 and, in particular, the microprocessor 131 are configured to consider the variation in the value of the resistance and the temperature of the light detection means 109 during the determination of the irradiance.

FIG. 2 shows a device 200 for measuring irradiance according to a third embodiment. The only difference between the device 200 and the device 100 according to the first or second embodiment is the fact that the device 200 does not comprise any communication means 135 enabling a remote communication.

The device 200 is mounted on a weather station 201 by using the connection means 111. Data are exchanged between the irradiance device 200 and the weather station 201. The modular weather station 201 can send data received to a wirelessly connected remote control unit, by using a communication means 203 positioned on the modular weather station 201. Thus, the irradiance device 200 can be simplified by using the already-existing communication means 203.

Due to a low electrical energy consumption, the device according to the first, to the third embodiment of the present disclosure can be energy-autonomous. For example, the irradiance device can comprise an energy supply autonomous device, in particular, solar, thermal and/or wind turbine energy. This enables the installation of the irradiance device without needing installation of electrical lines.

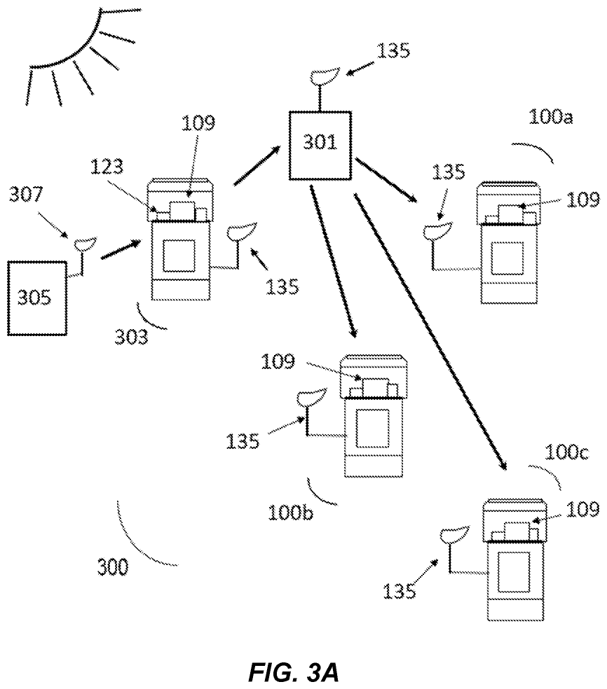

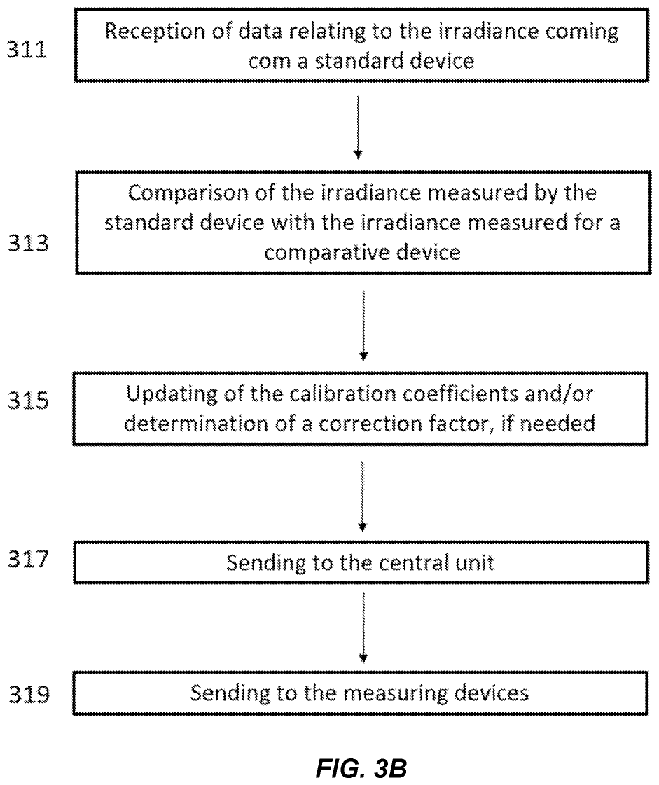

According to a fourth embodiment of the present disclosure, one or more devices 100 or 200 according to the embodiments described above can form a system for measuring solar irradiance with a comparative device and/or a central unit. Such a system for measuring irradiance 300 is illustrated in FIG. 3A.

The system for measuring irradiance 300 comprises a central unit 301, a comparative device 303 for measuring solar irradiance, and at least one other device for measuring irradiance, preferably several devices 100a, 100b, 100c for measuring solar irradiance according to the first, second or third embodiment. In this case, the devices 100a, 100b, 100c are already used and are, for example, placed in a field.

The comparative device 303 comprises a light detection means 109 of the same type as the devices 100a, 100b, 100c. Preferably, the comparative device 303 is a device according to the first, second or third embodiment, and thus also comprises a temperature measuring means 123. All the features of the devices 100a-100c and of the comparative device 303 of the fourth embodiment, which are common with the device 100 of the first embodiment illustrated in FIGS. 1a and 1b will not be described again, but reference is made to their description above with the same reference numbers used in FIGS. 1A to 1B. In a variant, the comparative device 303 and the central unit 301 are integrated in one single device.

The devices 100a, 100b, 100c, 301, 303 of the system comprise a communication means 135 and/or 203 that enables a communication between them or at least between the central unit 301 and each of the devices for measuring irradiance 100a, 100b, 100c.

The comparative device 303 is arranged in the proximity of or adjacent to a standard device 305 that cannot form part of the system 300. The standard device 305 has a greater accuracy relating to measuring the irradiance of the comparative device 303. The standard device 305 can be a weather station of a specialist service, such as Mete® France and/or other European or global equivalents.

The system 300 operates as follows, illustrated by FIG. 3B. The standard device 305 sends data, for example, relating to solar irradiance, by using its communication means 307. During step 311, these data can be received by the comparative device 303.

With the data received from the standard device 305, the comparative device 303 can perform a verification of its own irradiance measurement taken by its light detection device 109 according to the temperature T by comparing it with the irradiance measurement received from the standard device 305 such as illustrated by step 313.

In case of disagreement between the measurements, the comparative device 303 updates, as illustrated in step 315, the table of calibration coefficients and/or determines a correction factor to be applied to the values b(T) in the table of calibration coefficients.

Following the updating of its table of calibration coefficients, the comparative device 303 sends to step 317, the new table of calibration coefficients and/or the correction factor to the central unit 301 of the system 300, which, in step 319, relays this new information to the devices for measuring irradiance 100a, 100b, 100c. Thus, the devices for measuring irradiance 100a, 100b, 100c can update their table of calibration coefficients in their respective memory 133.

Based on the data relating to the irradiance of the comparative device 303, the system 300 can initiate the updating of the calibration coefficients of the other devices 100a, 100b, 100c without an agent needing to move. Changes in behavior due to aging can, therefore, for example, be considered, which, in first approximation, are the same for devices manufactured in the same way and using the same type of light detection means 109.

The central unit 301 can also be configured to remotely test the correct operation of the devices 100a, 100b, 100c already in position. Following the test, one or more of the devices 100a, 100b, 100c can be recalibrated and/or updated. If needed, it can also be decided to perform maintenance of the device onsite.

Thus, it becomes possible to remotely know the operation of the device according to the present disclosure, without needing to be returned to the factory to be inspected. The intervention is done digitally without needing a physical interaction with the hardware components of the device.

A certain number of embodiments of the present disclosure have been described. However, it will be understood that various modifications and improvements can be applied without departing from the scope of the following claims.

1. A pyrometer device for measuring solar irradiance, comprising:
a light detection means comprising a photodiode;
a temperature measuring means the temperature measuring means being configured to measure the temperature of the light detection means; and
a data processing means configured to determine the irradiance by considering, in situ, the temperature of the light detection means.

2. The device of claim 1, wherein the temperature measuring means and the light detection means are mounted on one same printed circuit.

3. The device of claim 1, wherein the light detection means is a photodiode configured to be used in inverse polarization.

4. The device of claim 1, further comprising a conversion means the conversion means being connected to the light detection means.

5. The device of claim 4, wherein the conversion means is mounted on a same printed circuit on which are mounted the temperature measuring means and the light detection means.

6. The device of claim 1, wherein the data processing means comprises a microprocessor, a memory and an analog-to-digital converter.

7. The device of claim 6, wherein the memory comprises a table of calibration coefficients according to the temperature, and the data processing means is configured to determine the irradiance according to the temperature by using one or more calibration coefficients of the table of calibration coefficients stored in the memory.

8. The device of claim 1, further comprising an optical filter upstream of the light detection means with respect to incoming radiation during use.

9. The device of claim 8, wherein the optical filter is a neutral density filter.

10. The device of claim 1, further comprising a communication means.

11. A system for measuring solar irradiance comprising:
at least one device for measuring solar irradiance according to claim 1;
a comparative device having a light detection means of the same type as the at least one device for measuring solar irradiance;
wherein the comparative device comprises a communication means; and
the comparative device is configured to send information relating to a calibration coefficient to the at least one device for measuring irradiance via the communication means.

12. The system of claim 11, wherein the comparative device comprises a temperature measuring means configured to measure the temperature of the light detection means, and wherein the comparative device is configured to send the information relating to the calibration coefficient according to the temperature.

13. A method of measuring solar irradiance using a device according to according to claim 1, comprising:
a step of measuring a voltage representative of an incident irradiance on the light detection means;
a step of measuring the temperature of the light detection means by a temperature measuring means; and
a step of determining the incident irradiance in situ by the data processing means based on the voltage measured and by using a calibration coefficient of a table of calibration coefficients according to the temperature measured.

14. The method of claim 13, wherein the device a cording to claim 1 further comprises a communication means, the method further comprising a step of receiving one or more calibration coefficient values modified by the communication means and replacing the existing corresponding value(s) in the data processing means by the value(s) received.

15. The method of claim 14, wherein the device according to claim 1 is part of a system comprising, a comparative device having a light detection means of the same type as the at least one device for measuring solar irradiance, the comparative device comprising a communication means, the comparative device configured to send information relating to a calibration coefficient to the at least one device for measuring irradiance via the communication means, the method further comprising:
a step of receiving by the comparative device, data of the solar irradiance measured by a standard device having an accuracy greater than the light detection means of the comparative device, the comparative device being positioned adjacent to the standard device; and
a step of comparing the data of the irradiance received with the irradiance measured by the comparative device;
a step of calculating/updating calibration coefficients of the comparative device modified according to the data of the solar irradiance received by the comparative device; and
a step of sending modified calibration coefficients of the comparative device to the at least one device for measuring solar irradiance.

16. The device of claim 2, wherein the temperature measuring means and the light detection means are mounted side-by-side on one same printed circuit.

17. The device of claim 4, wherein the conversion means comprises a resistance.

18. The device of claim 17, wherein the resistance comprises a fixed resistance.

19. The device of claim 6, wherein the memory comprises an EEPROM memory.

20. The device of claim 9, wherein the optical filter is a neutral density reflection filter.
